(19) United States
(12) Patent Application Publication
(10) Pub. No.: US 2024/0313346 A1
(43) Pub. Date: Sep. 19, 2024

(54) BATTERY MODULE AND BATTERY PACK INCLUDING THE SAME

(71) Applicant: LG ENERGY SOLUTION, LTD., Seoul (KR)

(72) Inventors: Sunghwan JANG, Daejeon (KR); Junyeob SEONG, Daejeon (KR); Myungki PARK, Daejeon (KR); Won Kyoung PARK, Daejeon (KR)

(73) Assignee: LG ENERGY SOLUTION, LTD., Seoul (KR)

(21) Appl. No.: 18/574,691

(22) PCT Filed: Aug. 4, 2022
(86) PCT No.: PCT/KR2022/011517

§ 371 Date: Dec. 27, 2023

(30) Foreign Application Priority Data
Aug. 19, 2021 (KR) 10-2021-0109752

(51) Int. Cl. H01M 50/383; B60L 50/60; H01M 50/211; H01M 50/291; H01M 50/30

(52) U.S. Cl. CPC H01M 50/383; H01M 50/211; H01M 50/291; H01M 50/394; B60L 50/60

(57) ABSTRACT

A battery module includes: a plurality of battery cell stacking bodies including a plurality of battery cells; a frame member for receiving the battery cell stacking bodies; and at least one cell barrier structure body disposed between the battery cell stacking bodies. The cell barrier structure body includes two planar members in parallel to the battery cells, and a venting passage formed by the two planar members, and one of the two planar members includes a first opening formed to be opened toward the battery cell stacking body.

### TECHNICAL FIELD

This application claims priority to and the benefit of Korean Patent Application No. 10-2021-0109752 filed in the Korean Intellectual Property Office on Aug. 19, 2021, the entire contents of which are incorporated herein by reference.

The present invention relates to a battery module and a battery pack including the same, and particularly relates to a battery module for improving safety and venting performance and a battery pack including the same.

### BACKGROUND ART

As technical developments and demands on mobile devices increase, demands on rechargeable batteries as energy sources are steeply increasing. Accordingly, studies on the rechargeable batteries for satisfying various demands are in active progress.

The rechargeable batteries are gaining much attention as energy sources for power-based devices such as electric bicycles, electric vehicles, and hybrid electric vehicles in addition to mobile devices such as mobile phones, digital cameras, and laptops.

Recently, as needs for a large-capacity secondary battery structure increase in addition to the use as an energy storing source of the secondary battery, needs for the battery packs in a medium to large module structure in which battery modules in which secondary batteries are coupled in series or in parallel are gathered are increasing. The battery pack consists mainly of a battery module composed of at least one battery cell, and is composed by adding other constituent elements by using at least one battery module. Since the battery cells constituting the battery module are composed of a chargeable and dischargeable rechargeable battery, such a high power/large capacity rechargeable battery generates a large amount of heat during charge and discharge processes. Particularly, one or a couple of battery cells per device are used for small mobile devices, whereas medium and large devices such as automobiles require high power/large capacity. Therefore, a medium or large-sized battery module with a plurality of battery cells electrically connected to each other is used.

Since it is preferable for medium and large battery modules to be manufactured with as small a size and weight as possible, a prismatic battery and a pouch-type battery, which may have a high integration degree and have a small weight with respect to capacity, are mainly used as a battery cell of the medium and large battery modules.

When some of the battery modules receive an overvoltage or an overcurrent or they are overheated while in the above-noted integrated state, safety and operation efficiency of the battery pack may be problematic. Specifically, the capacity of the battery pack is in the increasing trend to improve mileage, and hence, there is a need to design a structure satisfying reinforcing safety standards and obtaining safety of vehicles and drivers.

FIG. 1 shows a perspective view of a conventional battery module.

As shown in FIG. 1, regarding the battery module 1, when a battery pack is configured, a plurality of battery modules 1 are disposed near the same. In this instance, when thermal runaway is generated in one battery module 1 and is not quickly discharged to an outside, high-temperature gas and flame therein are exploded at once and are transmitted to an adjacent battery module 1. By this, thermal runaway is successively generated to the battery module 1 and damage of the battery module 1 is also transmitted.

Therefore, it is required to prevent propagation to adjacent modules and minimize damage when the thermal runaway is generated, and for this purpose, needs of a configuration for minimizing the damage by efficiently discharging the gas and flame generated in part of the battery module without an additional transition.

### DISCLOSURE

The present invention has been made in an effort to provide a battery module for quickly discharging flame and gas to an outside to prevent transition of the thermal runaway phenomenon between a battery cell and battery modules when an ignition phenomenon is generated in the battery module, and a battery pack including the same.

The technical problem to be solved of the present invention is not limited to the above-described problem, and problems not mentioned will be clearly understood by a person of ordinary skill in the art from the present specification and the accompanying drawings.

An embodiment of the present invention provides a battery module including: a plurality of battery cell stacking bodies, each including a plurality of battery cells; a frame member for receiving the battery cell stacking bodies; and at least one cell barrier structure body disposed between the battery cell stacking bodies, wherein the cell barrier structure body includes two planar members in parallel to the battery cells, and a venting passage formed by the two planar members, and a first of the two planar members includes a first opening formed to be opened toward a first of the plurality of battery cell stacking bodies.

The cell barrier structure body may include a first end and a second end, and the first opening may be formed near the first end, and the second end may be connected to a first outlet communicating with an outside of the battery module.

The battery module may further include a first end plate and a second end plate for covering respective end portions of the battery cell stacking body, wherein the first end plate may include the first outlet.

The battery module may further include at least one external venting passage disposed on a side of the frame member.

The external venting passage may be integrally formed with the frame member.

The external venting passage may be formed with an external venting structure separately formed from the frame member.

The external venting passage may include a first end and a second end, and may include a second opening disposed near the first end and formed to be opened toward one of the plurality of battery cell stacking bodies.

The second end of the external venting passage may be connected to a second outlet communicating with the outside of the battery module.

The second end plate may not include the first outlet, and a first opening of the venting passage may be connected to the external venting passage by a space between an end portion of the battery cell stacking body and the second end plate.

Another embodiment of the present invention provides a battery pack including a battery module.

According to the embodiments, in the battery module according to the present invention and the battery pack including the same may, when an ignition phenomenon is generated in the battery module, it quickly discharges the gas and flame to the outside of the battery module, thereby preventing the consecutive thermal runaway phenomenon in the battery module and transmission of the thermal runaway to the adjacent battery module.

The effects of the object of the present invention are not limited to the above-described effects, and effects not mentioned will be clearly understood by a person of ordinary skill in the art from the present specification and the accompanying drawings.

### DESCRIPTION OF THE DRAWINGS

FIG. 1 shows a perspective view of a conventional battery module.

FIG. 2 shows a perspective view of a battery module according to an embodiment of the present invention.

FIG. 3 shows an exploded perspective view of a battery module of FIG. 2.

FIG. 4 shows a cross-sectional view with respect to a line IV-IV′ of FIG. 2.

FIG. 5 shows a perspective view of a cell barrier structure body of FIG. 2.

FIG. 6A and FIG. 6B show discharging of gas when thermal runaway is generated in a battery module of FIG. 2.

FIG. 7A shows a perspective view of an external venting passage of FIG. 2, and FIG. 7B shows a perspective view of a variation of FIG. 7A.

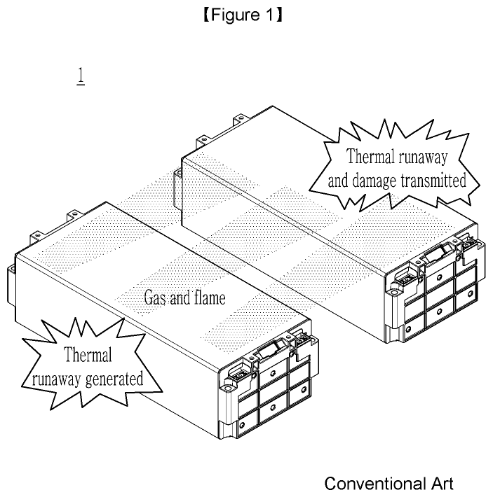

### MODE FOR INVENTION

The present invention will be described more fully hereinafter with reference to the accompanying drawings, in which embodiments of the invention are shown. As those skilled in the art would realize, the described embodiment may be modified in various different ways, all without departing from the spirit or scope of the present invention.

In order to clearly describe the present invention, parts that are irrelevant to the description are omitted, and identical or similar constituent elements throughout the specification are denoted by the same reference numerals.

The size and thickness of each element are arbitrarily illustrated for ease of description, and the present disclosure is not necessarily limited to those illustrated in the drawings. In the drawings, the thickness of layers, films, panels, regions, etc., are enlarged for clarity. The thicknesses of some layers and regions are exaggerated.

Unless explicitly described to the contrary, the word “comprise” and variations such as “comprises” or “comprising”, will be understood to imply the inclusion of stated elements but not the exclusion of any other elements.

The phrase “in a plan view” or “on a plane” means viewing a target portion from the top, and the phrase “in a cross-sectional view” or “on a cross-section”means viewing a cross-section formed by vertically cutting a target portion from the side.

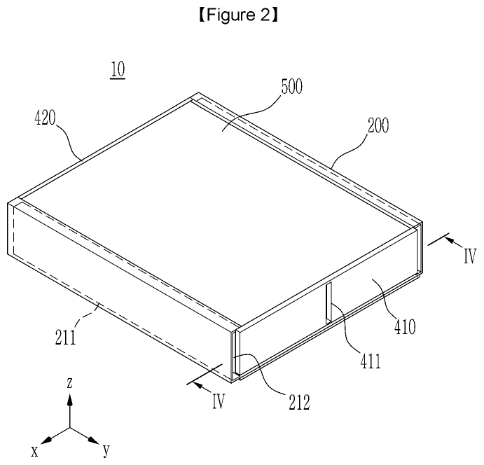

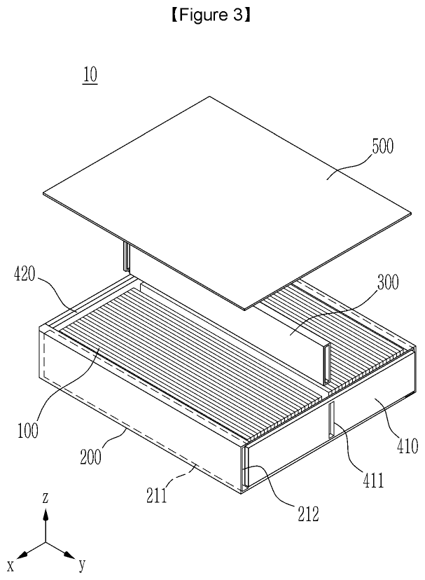

A battery module according to an embodiment of the present invention will now be described with reference to FIG. 2 to FIG. 5.

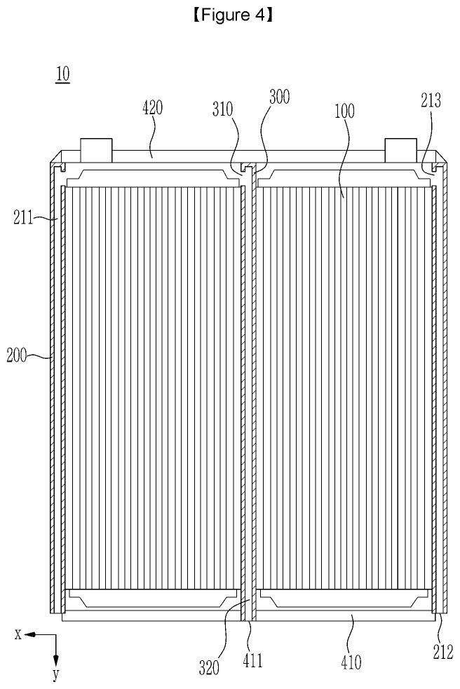

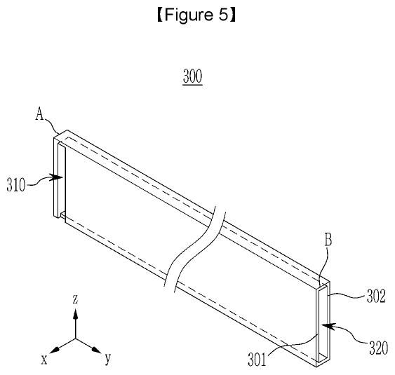

FIG. 2 shows a perspective view of a battery module according to an embodiment of the present invention, FIG. 3 shows an exploded perspective view of a battery module of FIG. 2, FIG. 4 shows a cross-sectional view with respect to a line IV-IV′ of FIG. 2, and FIG. 5 shows a perspective view of a venting member of FIG. 2.

Referring to FIG. 2 to FIG. 4, the battery module 10 includes a plurality of battery cell stacking bodies 100 including a plurality of battery cells, a frame member 200 for receiving lower sides and lateral sides of the battery cells stacking bodies 100, front and rear sides of the frame member 200 being opened, a cell barrier structure body 300 disposed between neighboring battery cell stacking bodies 100 from among the battery cell stacking bodies 100, end plates 410 and 420 disposed near front and rear sides of the battery cell stacking body 100 and covering the opened front and rear sides of the frame member 200, and an upper cover 500 for covering an upper side of the battery cell stacking body 100 and combined to the frame member 200. In the drawings to be described hereinafter, front and rear directions may be + and − directions in a y-axis direction, upper and lower directions may be + and − directions in a z-axis direction, and a lateral side direction may be an x-axis direction.

The frame member 200 may be a U-shaped frame for receiving a lower side and a lateral side of the battery cell stacking body 100, front and rear sides thereof being opened. The upper cover 500 may cover the upper side of the battery cell stacking body 100 and may be combined to the frame member 200. However, the configurations of the frame member 200 and the upper cover 500 are not limited thereto, they may have an integrally formed square pipe shape, or the configuration for covering the lower portion of the battery cell stacking body 100 may have a planar shape, and the configuration for covering the upper portion thereof may have a frame in a U shape turned upside down, and they are not specifically restricted.

The battery cell stacking body 100 may be formed by stacking a plurality of battery cells. It is preferable for the battery cell to be a pouch-type battery cell. For example, the battery cell may be manufactured by accommodating an electrode assembly in a pouch case of a laminate sheet including a resin layer and an inner layer, and thermally fusing a sealing portion of the pouch case. The battery cell may have a rectangular sheet-type structure. The battery cell may be multiple, and a plurality of battery cells are stacked to be electrically connected to each other to form the battery cell stacking body 100.

The battery cell stacking body 100 may be included as a multiple with the cell barrier structure body 300 therebetween in one frame member 200. For example, as shown in the drawing, two battery cell stacking bodies 100 may be disposed with their lateral sides facing each other. In this instance, a plurality of battery cell stacking bodies 100 may have differences according to positions, and may be identically manufactured battery cell stacking bodies. They may be electrically connected to each other in one frame member 200.

The end plates 410 and 420 may be made of a same material as the frame member 200, and may be fixed to the frame member 200 by a method such as a welding bonding. However, without being limited thereto, fixing methods for blocking an interior of the frame member 200 from external conditions may be appropriately applied. The end plates 410 and 420 may be disposed to cover the front side and the rear side of the battery cell stacking body 100, for example, the first end plate 410 may be disposed to cover the front side, and the second end plate 420 may be disposed to cover the rear side. Respective configurational differences will be described in a later portion of the present specification.

Referring to FIG. 2 to FIG. 5, the battery module 10 may include a cell barrier structure body 300 disposed between the neighboring battery cell stacking bodies 100. The cell barrier structure body 300 may, as shown in FIG. 5, include a space in which a first planar member 301 and a second planar member 301 in parallel to the lateral side of the battery cell stacking body 100 are disposed to face each other, and the corresponding space may form a venting passage 320 through which gas and flame generated by thermal runaway pass. The cell barrier structure body 300 may be made of the same substance as the frame member 200, the upper cover 500, and the end plates 410 and 420, and is not specifically limited. Further, to prevent propagation of flame, it may be made of a nonflammable member or may include a nonflammable coating layer.

The first planar member 301 of the cell barrier structure body 300 may include a first opening 310 opened to face the battery cell stacking body 100 disposed on the left in the drawing. The first opening 310 may be particularly formed near a first end A of the cell barrier structure body 300 in a length direction. The first opening 310 is connected to the venting passage 320.

A second end B of the cell barrier structure body 300 may be connected to a first outlet 411 formed in the first end plate 410. That is, the venting passage 320 connected to the first opening 310 formed in the first planar member 301 of the cell barrier structure body 300 extends inward along a length direction of the cell barrier structure body 300 to be opened at a second end B, and the venting passage 320 is connected to the first outlet 411 formed in the first end plate 410 so that the gas and flame generated at the thermal runaway may be discharged to the outside.

A second planar member 302 of the cell barrier structure body 300 includes no opening. That is, the second planar member 302 may, as shown in FIG. 5, have a planar shape including no opening. By this, the two battery cell stacking bodies 100 disposed with the cell barrier structure body 300 therebetween may be spaced from each other. Particularly, as the second end plate 420 disposed on the first end A of the cell barrier structure body 300 includes no outlet, the battery cell stacking bodies 100 disposed on respective sides with the cell barrier structure body 300 therebetween may be spaced from each other by a combination of the cell barrier structure body 300 and the second end plate 420. By this, when the thermal runaway is generated by the battery cell stacking body 100 on one side, the gas and flame may be discharged to the outside through a passage from the space in which the corresponding battery cell stacking body 100 is disposed, and the adjacent battery cell stacking body 100 may be spaced by the cell barrier structure body 300, thereby blocking transmission of the gas and flame.

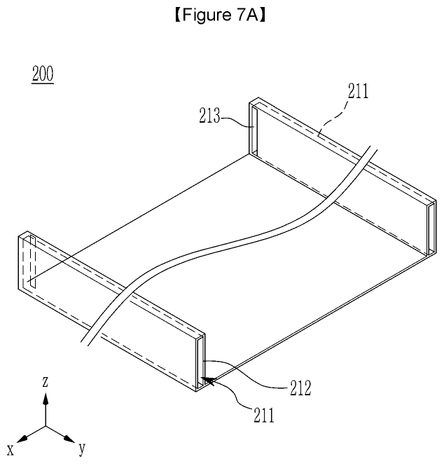

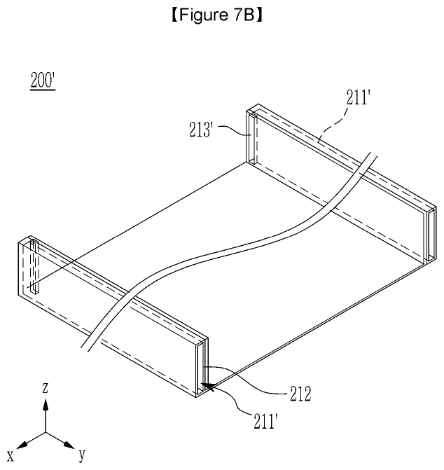

An external venting passage 211 will now be described with reference to FIG. 4, FIG. 7A, and FIG. 7B. FIG. 7A shows a perspective view of an external venting passage of FIG. 2, and FIG. 7B shows a perspective view of a variation of FIG. 7A.

Referring to FIG. 4, the external venting passage 211 may be formed along the lateral side of the frame member 200. The external venting passage 211 may have a pipe shape including a second opening 213 opened toward the facing battery cell stacking body 100 in a like way of the venting passage 320 of the cell barrier structure body 300. The second opening 213 may be formed near a rear side of the battery cell stacking body 100 (i.e., the first end A of the cell barrier structure body 300), and an end portion on an opposite side in the length direction, that is, the end portion disposed near a front side of the battery cell stacking body 100 may form a second outlet 212 communicating with the outside.

The external venting passage 211 may be integrally formed with the frame member 200, as shown in FIG. 7A. That is, double side walls of the frame member 200 are formed, and the external venting passage 211 may be formed by forming the second opening 213 on a side wall disposed inside. In another way, as shown in FIG. 7B, an external venting passage 211′ separately formed from the frame member 200′ may be provided. That is, a structure body including the external venting passage 211′ in a pipe shape may be attached to the side wall of the frame member 200′ made of one layer to thus form the configuration of the external venting passage 211′. In this instance, an opening may be formed in the side wall of the frame member 200′ corresponding to the second opening 213′ of the external venting passage 211′.

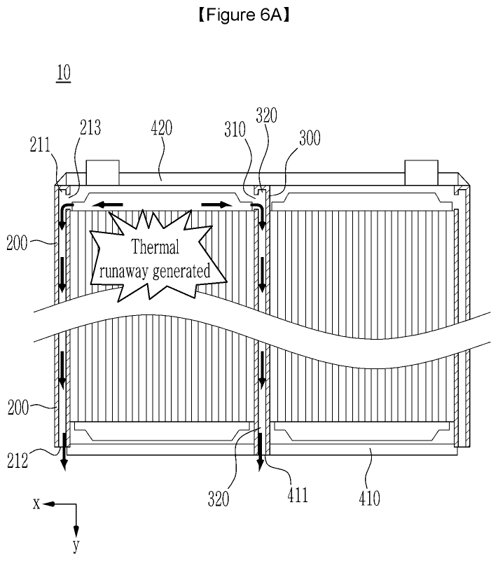

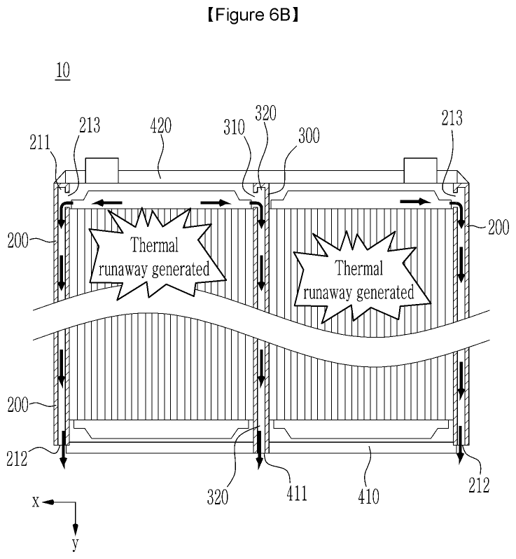

A process for discharging gas and flame when thermal runaway is generated in a battery module will now be described with reference to FIG. 6A and FIG. 6B.

FIG. 6A and FIG. 6B show discharging of gas when thermal runaway is generated in a battery module of FIG. 2.

Regarding a plurality of battery cell stacking bodies 100, a cell barrier structure body 300 having a venting passage 320 is disposed between adjacent battery cell stacking bodies 100, and an external venting passage 211 formed on a side wall of the frame member 200 is disposed on an outermost side so the battery cell stacking bodies 100 respectively face at least one of openings 310 and 213. Hence, the flame and gas generated by the battery cell stacking body 100 at the generation time of thermal runaway may move to the venting passage 320 and the external venting passage 211 through the openings 310 and 213 and may be discharged to the outside.

For example, as shown in FIG. 6A, when thermal runaway is generated in the battery cell stacking body 100 positioned on the left in the drawing, that is, the battery cell stacking body 100 facing the first planar member 301 in which the first opening 310 of the cell barrier structure body 300 is positioned, the gas and flame generated in the battery cell stacking body 100 may move along the venting passage 320 and the external venting passage 211 through the first opening 310 and the second opening 213 and may be discharged to the outside through the first outlet 411 and the second outlet 212. Here, since it is spaced from the adjacent battery cell stacking body 100 through the second planar member 320, the gas and flame may not be transmitted to the battery cell stacking body 100 positioned on the right in the drawing but may be quickly discharged to the outside, thereby preventing the adjacent battery cell stacking body 100 from being damaged.

Further, the first opening 310 may be connected to the second opening 213 through a space between the second end plate 420 and the battery cell stacking body 100. According to the above-noted configuration, the flame and gas therein may quickly move and may be discharged to the outside.

As shown in FIG. 6B, when the thermal runaway is generated in the battery cell stacking body 100 positioned on the right in the drawing, that is, the battery cell stacking body 100 facing the second planar member 302 in which no opening is positioned in the cell barrier structure body 300, the gas and flame generated in the battery cell stacking body 100 may move along the external venting passage 211 through the second opening 213 and may be discharged to the outside through the second outlet 212. In this instance, when the thermal runaway is generated in the battery cell stacking body 100 positioned on the right, it is spaced from the adjacent battery cell stacking body 100 through the second planar member 320, so the flame and gas may not be transmitted to the battery cell stacking body 100 positioned on the left in the drawing but may be quickly discharged to the outside, thereby preventing the adjacent battery cell stacking body 100 from being damaged. Also, as shown in FIG. 6B, when the thermal runaway is generated to the battery cell stacking bodies 100 on the respective sides, the flame and gas may be quickly discharged to the outside through the venting passage 320 of the cell barrier structure body 300 positioned in a center and the external venting passages 211 on the respective sides.

As described, according to the present embodiment, when the thermal runaway is generated in part of the battery cell stacking body 100 in the battery module 10, the generated flame and gas may move along the venting passage 320 formed on the cell barrier structure body 300 and the external venting passage 211 formed on the frame member 200 and may be quickly discharged to the outside, thereby suppressing heat energy from being stored in the battery module 10, and blocking the flame and gas from being transmitted to the other neighboring battery cell stacking bodies 100 and the battery module.

The above-described one or more battery modules according to the present embodiment may be installed together with various control and protection systems such as the BMS (Battery Management System) or the cooling system, and may form the battery pack. Particularly, when the battery module according to an embodiment of the present invention is disposed in the battery pack including battery modules, the flame and gas may be quickly discharged to the outside to thus prevent damage from being transmitted to the adjacent battery module outside the battery module or other parts of the battery pack. Further, when the battery module is disposed, the outlet for discharging the gas and flame may be disposed (e.g., at the rear side of the vehicle) near the place where the parts that may be damaged are not disposed outside the battery pack, thereby minimizing the influence according to the thermal runaway.

The battery module or the battery pack is applicable to various types of devices. In detail, these devices may be applied to a transportation apparatus such as an electric bicycle, an electric vehicle, a hybrid vehicle, and the like, but are not limited thereto, and may be applied to various devices that can use the secondary battery.

In the present embodiment, terms representing directions such as before, after, right, left, top, and bottom have been used, but they are for ease of description, and are variable depending on a position of a target material or a position of an observer.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

### DESCRIPTION OF SYMBOLS

10: battery module
100: battery cell stacking body
200: frame member
300: cell barrier structure body
310: first opening
320: venting passage
301: first planar member
302: second planar member
211, 211′: external venting passage
213: second opening
410: first end plate
420: second end plate
411: first outlet
212: second outlet

1. A battery module comprising:
a plurality of battery cell stacking bodies, each including a plurality of battery cells;
a frame member for receiving the battery cell stacking bodies; and
at least one cell barrier structure body disposed between the battery cell stacking bodies,
wherein the cell barrier structure body includes two planar members in parallel to the battery cells, and a venting passage formed by the two planar members, and a first of the two planar members includes a first opening formed to be opened toward a first of the plurality of battery cell stacking bodies.

2. The battery module of claim 1, wherein the cell barrier structure body includes a first end and a second end, and
wherein the first opening is formed near the first end, and the second end is connected to a first outlet communicating with an outside of the battery module.

3. The battery module of claim 2, further comprising a first end plate and a second end plate for covering respective end portions of the battery cell stacking body,
wherein the first end plate includes the first outlet.

4. The battery module of claim 3, further comprising at least one external venting passage disposed on a side of the frame member.

5. The battery module of claim 4, wherein the external venting passage is integrally formed with the frame member.

6. The battery module of claim 4, wherein the external venting passage is formed with an external venting structure separately formed from the frame member.

7. The battery module of claim 4, wherein the external venting passage includes a first end and a second end, and includes a second opening disposed near the first end and formed to be opened toward one of the plurality of battery cell stacking bodies.

8. The battery module of claim 7, wherein the second end of the external venting passage is connected to a second outlet communicating with the outside of the battery module.

9. The battery module of claim 4, wherein the second end plate does not include the first outlet, and
wherein a first opening of the venting passage is connected to the external venting passage by a space between an end portion of the battery cell stacking body and the second end plate.

10. The battery module of claim 1, wherein a second planar member in which the opening is not formed separates a second of the plurality of battery cell stacking bodies from the venting passage.

11. A battery pack comprising a battery module of claim 1.
